(19) United States
(12) Patent Application Publication
(10) Pub. No.: US 2015/0180083 A1
(43) Pub. Date: Jun. 25, 2015

(54) CYLINDRICAL BATTERY

(71) Applicant: SANYO Electric Co., Ltd., Osaka (JP)

(72) Inventors: Akira Nishida, Hyogo (JP); Yasuyuki Harada, Hyogo (JP); Akira Hayamizu, Hyogo (JP); Toshiyuki Ikegawa, Hyogo (JP); Kazuhiro Kitaoka, Hyogo (JP)

(73) Assignee: SANTO Electric Co., Ltd., Osaka (JP)

(21) Appl. No.: 14/571,486

(22) Filed: Dec. 16, 2014

(30) Foreign Application Priority Data
Dec. 25, 2013 (JP) 2013-266808

(51) Int. Cl. H01M 10/04

(52) U.S. Cl. CPC H01M 10/0431; H01M 10/0422

(57) ABSTRACT

A cylindrical battery comprises a spiral electrode assembly having a positive electrode plate being provided with a porous nickel sintered substrate using a nickel coated steel plate as a conductive core substrate, and containing a positive electrode active material mainly including a nickel hydroxide, a negative electrode plate, and a separator, and the positive electrode plate and the negative electrode plate are wound into a spiral form interposing the separator therebetween, and the positive electrode plate has a positive core substrate tab portion in which the conductive core substrate is exposed without the porous nickel sintered substrate at one end portion in the height direction, and in in a finally wound end portion of the spiral electrode assembly, a corner tip portion of the positive core substrate tab portion is bent in a direction toward an axis of the spiral electrode assembly.

### TECHNICAL FIELD

The present invention is related to a cylindrical battery.

### BACKGROUND ART

Conventionally, a cylindrical battery such as a nickel metal hydride battery, a nickel cadmium battery, a lithium battery, a lithium ion battery, or the like, contains a spiral electrode assembly in which a positive electrode plate and a negative electrode plate are wound into a spiral form interposing a separator therebetween, and a winding end portion of the spiral electrode assembly is fixed by an adhesive tape, and the spiral electrode assembly is inserted into a can.

At this time, the can where the spiral electrode assembly is inserted is any one of terminals having a positive electrode or a negative electrode.

Therefore, when any one of the positive or negative electrode plate, or current collector opposite to one polarity which the can has, contacts the can, an internal short circuit occurs.

For this reason, in order that it is prevented that the current collector disposed on the spiral electrode assembly contacts the can, it has been known that an insulating ring is disposed at a peripheral portion of the current collector on the spiral electrode assembly.

However, in manufacturing processes, by interference between a corner tip portion of a positive core substrate tab portion in the winding end portion of the spiral electrode assembly and manufacturing machines, the corner tip portion of the positive core substrate tab portion is in danger of bending in a direction outward a periphery of the spiral electrode assembly.

Further, when the insulating ring is disposed after the spiral electrode assembly is inserted into the can, the corner tip portion of the positive core substrate tab portion in the winding end portion of the spiral electrode assembly is caught by the inserted insulated ring, and the corner tip portion of the positive core substrate tab portion bends in the direction outward the periphery of the spiral electrode assembly, and then it is in danger of an internal short circuit by the can contacting the positive core substrate tab portion.

Additionally, even when the corner tip portion does not bend in the outward direction and in assembling the inner short circuit does not occurs, as the insulating ring is caught by the corner tip portion and the insulating ring is not inserted enough, it occurs that the corner tip portion contacts the can by vibration of the battery or the like.

Therefore, the following has been proposed. In the lithium battery, before winding the electrode plates a curving work onto an end of the electrode plate is performed so that the end has a curvature in the end being located in a longitudinal direction of the plate, and in the winding step, the winding work is performed such that the curvature curves toward an internal side of the electrode assembly, and also after winding the curvature curves toward an internal side of the electrode assembly.

### CITATION LIST

### Patent Literature

Patent Literature 1: Japanese Laid-Open Patent Publication No. 2008-112638

### SUMMARY OF THE INVENTION

In the above patent literature 1, the curving work onto the end of the electrode plate is performed so that the whole surface of the end has a curvature in the end being located in the longitudinal direction of the plate. It is a reason why the positive electrode plate of the above patent literature is relatively flexible and the curving work can be done.

On the contrary, in an alkaline secondary battery using a sintered positive electrode plate having a high strength, when the curved work is performed, a positive electrode active material is removed from the sintered substrate or is damaged, and it occurs that powder of the positive electrode active material or the like from such removal and damage penetrates a separator and it causes an internal short circuit.

Further, as the corner tip portion of the positive core substrate tab portion bends in the outward direction by the insulating ring, it is considered that the corner tip portion of the end in the positive core substrate tab portion is cut.

However, in this case, as a step of cutting the corner tip portion is added, cost of the battery products are increased. In addition, burrs at the cut surface, or adhesion of the cut core substrate pieces to the electrode plate cause an inner short circuit.

A cylindrical battery of the present disclosure comprises a spiral electrode assembly having a positive electrode plate being provided with a porous nickel sintered substrate using a nickel coated steel plate as a conductive core substrate, and containing a positive electrode active material mainly including a nickel hydroxide, a negative electrode plate, and a separator, and the positive electrode plate and the negative electrode plate are wound into a spiral form interposing the separator therebetween, and the positive electrode plate has a positive core substrate tab portion in which the conductive core substrate is exposed without the porous nickel sintered substrate at one end portion in the height direction, and in a winding end portion of the spiral electrode assembly, a corner tip portion of the positive core substrate tab portion is bent in a direction toward an axis of the spiral electrode assembly.

Further, it is desirable that a bent angle θ of the corner tip portion of the positive core substrate tab portion to the direction to the axis of the spiral electrode assembly is at the range of 45°≦θ≦180°.

In a cylindrical battery of the present disclosure, in a winding end portion of the spiral electrode assembly, a corner tip portion of the positive core substrate tab portion in which the conductive core substrate is exposed without the porous nickel sintered substrate is bent by a curving work in a direction toward an axis of the spiral electrode assembly.

This prevents interference between a corner tip portion of a positive core substrate tab portion in the winding end portion of the spiral electrode assembly and manufacturing machines in manufacturing processes. Further, when the insulating ring is disposed after the spiral electrode assembly is inserted into the can, it is prevented that the corner tip portion of the positive core substrate tab portion in the winding end portion of the spiral electrode assembly is caught by the inserted insulated ring. Moreover, it is prevented that the corner tip portion of the positive core substrate tab portion bends in the direction outward the periphery of the spiral electrode assembly and an internal short circuit by the can contacting the positive core substrate tab portion occurs.

In addition, this prevents the following. In a battery using a sintered positive electrode plate having a high strength, when the curved work is performed, a positive electrode active material is removed from the sintered substrate or is damaged, and it occurs that powder of the positive electrode active material or the like from such removal and damage penetrates a separator and it causes an internal short circuit.

Further, a bent angle 0 of the corner tip portion of the positive core substrate tab portion to the direction to the axis of the spiral electrode assembly is at the range of 45°≦θ≦180°. This prevents insertion defect by inserting the insulating ring.

Here, it is desirable that a length (L) (as shown in FIG. 2) of the bent portion of the positive core substrate tab portion is equal to or less than 1.0 mm, because when the length (L) (as shown in FIG. 2) of the bent portion of the positive core substrate tab portion is more than 1.0 mm, it is difficult that the bent portion of the positive core substrate tab portion is bent in a circle shape enough in preparing the spiral electrode assembly.

In this time, as a way for the curving work in the bent portion of the positive core substrate tab portion, after the positive core substrate tab portion is bent in a state of the positive electrode plate, the spiral electrode assembly can be produced. And also after the preparation of the spiral electrode assembly, the positive core substrate tab portion can be bent. When the positive core substrate tab portion is bent in a state of the positive electrode plate and then the spiral electrode assembly is produced, it is easy that the positive core substrate tab portion is bent at a predetermined size.

Further, when after the preparation of the spiral electrode assembly the positive core substrate tab portion is bent, the portions other than the positive core substrate tab portion at the time of the curving work might be damaged (for example, removal of a negative electrode active material at the periphery or the like). Therefore, it is desirable that the positive core substrate tab portion is bent in a state of the positive electrode plate and then the spiral electrode assembly is produced

Further, in order to stop the winding of the spiral electrode assembly, it is desirable that a winding stop adhesive tape is disposed along on the end of the negative electrode plate in the elongated direction. It is a reason why as the winding stop adhesive tape is disposed along on the active material of the end of the negative electrode plate and covers the negative electrode plate, removal of the negative electrode material in the vicinity of the positive electrode plate which is caused by soaking into an alkaline electrolyte or expansion and contraction with charging and discharging, is prevented, and inner short circuit is prevented.

### BRIEF DESCRIPTION OF DRAWINGS

FIG. 1 is a main portion schematic view of a spiral electrode assembly in a cylindrical battery of the present embodiment.

FIG. 2 is a front view of a positive electrode plate in the cylindrical battery of the present embodiment.

FIG. 3 is a perspective view of the spiral electrode assembly in the cylindrical battery of the present embodiment.

FIG. 4 is a sectional view of the cylindrical battery of the present embodiment.

### DESCRIPTION OF EMBODIMENTS

Hereinafter, embodiments for carrying out the invention will be described in detail with reference to examples. However, the examples described below are an illustrative example for embodying the technical spirit of the invention, is not intended to limit the invention to the examples, and the invention may be equally applied to various modified ones without departing from the technical spirit described in the claims.

### EXAMPLE

### Fabrication of the Nickel Sintered Positive Electrode Plate

Methyl cellulose (MC) as a thickener, polymeric hollow microspheres having a pore size of 60 μm, and water were mixed with nickel powder, and the whole was kneaded to prepare a nickel slurry. Next, the nickel slurry was applied onto both sides of a punching metal made from a nickel coated steel plate as a conductive core substrate so as to have a predetermined thickness, and then the plate was heated in a reducing atmosphere at 1000° C. to remove the coated thickener and polymeric hollow microspheres and to sinter the nickel powder to each other. The porous nickel sintered substrate having a porosity of about 85% was obtained.

Here, when the nickel slurry was applied, the nickel slurry was not applied in a predetermined width in the elongated direction of the conductive core substrate. This portion was used as a positive core substrate tab portion where the conductive core substrate was exposed.

The obtained porous nickel sintered substrate was immersed in the impregnating solution prepared by mixing nickel nitrate and zinc nitrate so as to have a predetermined molar ratio, the nickel salt and the zinc salt were held within pores of the porous nickel sintered substrate.

Next, this porous nickel sintered substrate was immersed an aqueous sodium hydroxide (NaOH) solution having a specific gravity of 1.3. The nickel salt and the zinc salt were converted into nickel hydroxide and zinc hydroxide respectively in the alkaline treatment.

Next, the substrate was sufficiently washed with water to remove the alkaline solution, and then dried. An electrode active material mainly including a nickel hydroxide was filled within pores of the porous nickel sintered substrate.

Such a series of positive electrode active material filling operations were repeated a predetermined times to fill the porous nickel sintered substrate with a predetermined amount of the positive electrode active material.

After it was cut in a predetermined size, the nickel sintered positive electrode plate was prepared.

Next, the corner tip portion of the positive core substrate tab portion at the end of the nickel sintered positive electrode plate was bent.

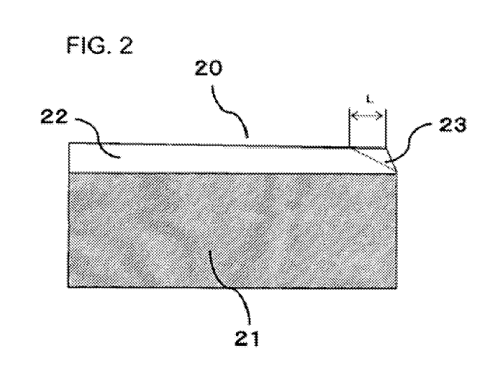

FIG. 2 shows a front view of the positive electrode plate which configures the spiral electrode assembly. In the positive electrode plate 20, the corner tip portion 23 of the positive core substrate tab portion 22 located in the winding end portion of the spiral electrode assembly, was bent by a curving work in a direction toward an axis of the spiral electrode assembly.

Here, a length (L) (as shown in FIG. 2) of the bent portion of the positive core substrate tab portion 22 was equal to or less than 1.0 mm.

### Preparation of Hydrogen Storage Alloy

A hydrogen storage alloy powder was prepared in the following way. In addition to Neodymium (Nd) as 100% by mass, magnesium (Mg), nickel (Ni), and aluminum (Al) were mixed in a predetermined molar ratio. Next, the mixture was placed in a high-frequency induction heater in an argon gas atmosphere for ten hours at 1000° C. to be melted, and then rapidly cooled to prepare a hydrogen storage alloy ingot having a composition of Nd_{0.9}Mg_{0.1}Ni_{3.3} Al_{0.02}.

Next, the obtained hydrogen storage alloy ingot was mechanically pulverized in an inert gas atmosphere, and particles of sizes between 400 mesh to 200 mesh were sifted out, and then the powder of the hydrogen storage alloy was obtained.

Here, this powder was analyzed by a laser diffraction/scattering particle size analyzer to determine its particle size distribution. As a result, the particle size obtained at the mean value of weight was found to be 25 μm.

### Preparation of Hydrogen Storage Alloy Negative Electrode Plate

Then, 100 parts by mass of the obtained hydrogen storage alloy powder was mixed with 0.5 part by mass of styrene butadiene rubber (SBR) as a water-insoluble polymer binder, 0.3 part by mass of carboxymethyl cellulose (CMC) as a thicker, and an appropriate amount of pure water and the whole was kneaded to prepare a negative electrode active material slurry.

Next, the obtained negative electrode active material slurry was applied to both sides of a negative electrode core substrate made from a punching metal (made from a nickel coated steel plate). Then, the substrate was dried and rolled so as to have a predetermined packing density, and cut into a predetermined size to prepare the hydrogen storage alloy negative electrode

### Preparation of Separator

Polyolefin-based synthetic resin adhesion fibers (core was polypropylene, sheath was low-melting polyethylene), high-strength polypropylene-based fibers was used as material, and wet basic fabric having a basis weight of 50 g/m² was prepared at a drying temperature of about 135° C. in a conventional way.

Next, the basic fabric was immersed in fuming sulfuric acid as a conventional way and provided with hydrophilicity.

Here, in the basic fabric the ratio of sulfur atoms to carbon atoms (S/C) was 2.3 to 1000, this was used as the separator by the sulfonation treatment.

Further, in the above basic fabric, the surfaces were improved and provided with hydrophilicity by a conventional way of fluorine gas treatment, this was used as the separator by the fluorine treatment.

Here, either thickness of the separator by the sulfonation treatment or by the fluorine treatment was about 0.14 mm.

### Preparation of the Spiral Electrode Assembly

By using the above positive and negative electrode plates interposing the separator therebetween of the polyolefin-based synthetic resin nonwoven fabric, the plates were disposed and wound in a spiral form, and the spiral electrode assembly was prepared such that the corner tip portion of the positive core substrate tab portion was bent in the direction toward the axis of the spiral electrode assembly.

Here, the negative electrode plate was disposed in at least one part of the outermost periphery of the spiral electrode assembly, and the spiral electrode assembly was fixed by a winding stop adhesive tape. The winding stop adhesive tape was disposed along on the end of the negative electrode plate in the elongated direction, and the surface of the negative electrode plate was covered.

### Measurement of the Bent Angle θ

In the winding end portion of the positive electrode, a bent angle (θ) of the corner tip portion of the positive core substrate tab portion was measured.

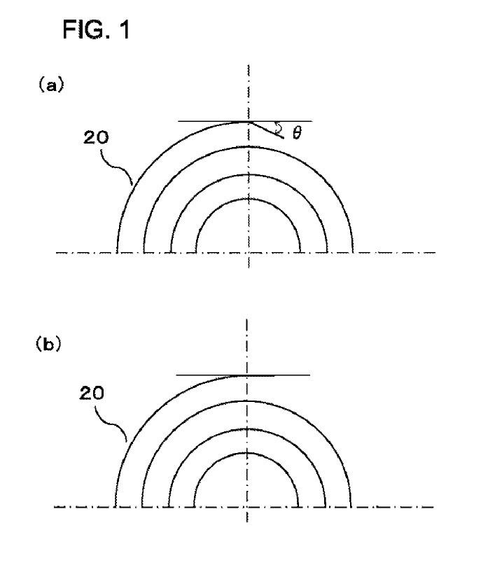

FIG. 1 shows a schematic view in a state that a curving work of a bent angle θ at the corner tip portion of the positive core substrate tab portion was carried out.

FIG. 1(a) shows that the curving work of the bent angle 0 at the corner tip portion of the positive core substrate tab portion was carried out.

FIG. 1(b) shows that the curving work at the corner tip portion of the positive core substrate tab portion was not carried out, namely θ=0°.

### Preparation of Alkaline Electrolyte

The alkaline electrolyte was a mixture of sodium hydroxide (NaOH), potassium hydroxide (KOH), lithium hydroxide (LiOH), and the alkaline electrolyte was 7.0 mol/L.

### Preparation of Nickel Metal Hydride Battery

The positive electrode core substrate was exposed as the positive electrode core substrate tab portion at the top portion of the obtained spiral electrode assembly, and the negative electrode core substrate was exposed as the negative electrode core substrate tab portion at the lower portion thereof. A positive electrode current collector was connected by welding to the positive electrode core substrate tab portion, and a negative electrode current collector was connected by welding to the negative electrode core substrate tab portion.

This spiral electrode assembly was stored into a can which was made of a nickel coated iron and had a tube shape including a bottom portion. Then, the negative electrode current collector was connected by welding to the inner side of the bottom portion of the can.

Here, a positive electrode current collecting lead was disposed on the positive electrode current collector which was connected by welding on the top portion of the spiral electrode assembly.

Next, the insulating ring was inserted at the upper inner peripheral portion of the can, and by making a groove on the upper peripheral part of the can an annular groove was formed at the upper end portion of the insulating ring. After that, the alkaline electrolyte was poured. Then, a sealing plate was disposed on the positive electrode current collecting lead. Here, the sealing plate had a positive electrode cap. Inside the positive electrode cap, a pressure valve was arranged including a valve element that deforms with a particular pressure and springs. Here, the sealing plate had an insulating gasket on a peripheral part thereof in advance.

Next, a pair of welding electrodes were disposed on the sealing plate and on the bottom portion, and while a pressure was applied between a pair of the welding electrodes, voltage was applied, and welding current flowed. Thus, the positive electrode current collecting lead was connected by welding to the sealing plate.

Then, the open end edge of the can was caulked inward, to thereby produce a nickel metal hydride battery.

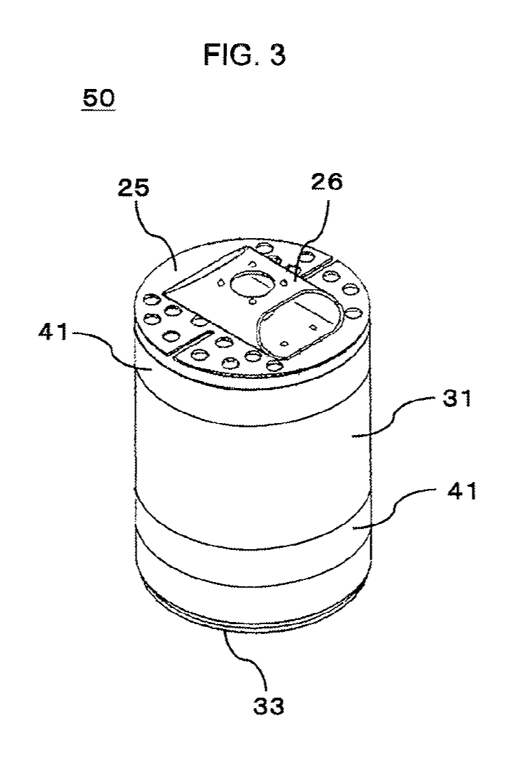

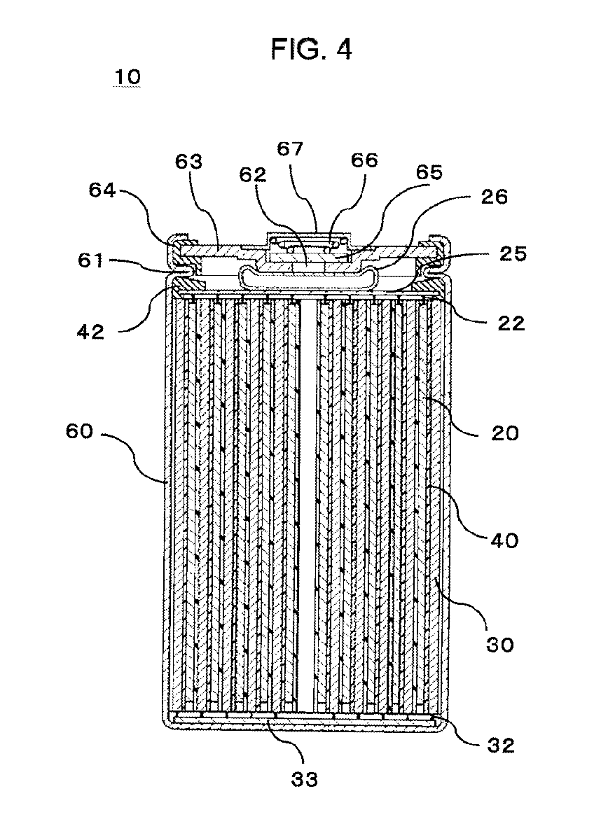

The concrete configuration of the nickel metal hydride battery produced in this way is explained in the following by using FIG. 3 and FIG. 4.

In the spiral electrode assembly 50, the positive electrode plate 20 and the negative electrode plate 30 which were prepared in the above were wound in an insulating state to each other by interposing the separator 40 therebetween, and fixed by the winding stop adhesive tape 41. The positive electrode plate 20 included the positive electrode active material layer 21 in which the positive electrode active material mainly including the nickel hydroxide was filled within pores of the porous nickel sintered body formed onto both sides of the punching metal made from a nickel coated steel plate as the conductive core substrate, and the positive electrode core substrate tab portion 22 without the positive electrode active material layer. The negative electrode plate 30 includes the negative electrode active material layer 31 which had the powder of the hydrogen storage alloy as the negative electrode active material on both sides of the negative electrode core substrate of the punching metal made from the nickel coated steel plate, and the negative electrode core substrate tab portion 32 without the negative electrode active material layer.

The negative electrode core substrate tab portion 32 at the lower portion of the spiral electrode assembly 50 is connected by spot welding to the negative electrode current collector 33, and the positive electrode core substrate tab portion 22 at the top portion of the spiral electrode assembly 50 was connected by spot welding to the positive electrode current collector 25. Further, the positive electrode current collecting lead 26 was disposed on the positive electrode current collector 25. The spiral electrode assembly 50 was inserted into the can 60 which was made of the nickel coated iron and had a tube shape including the bottom portion. Then, the negative electrode current collector 33 was connected by spot welding to the inner side of the bottom portion of the can 60.

Next, the insulating ring 42 was inserted at the upper opening peripheral portion of the can 60, and by making a groove on the upper peripheral part of the can 60 an annular groove 61 was formed at the upper end portion of the insulating ring 42. After that, the alkaline electrolyte was poured. The sealing plate 63 made of a nickel coated iron was disposed at the opening end side of the can in a state that the sealing plate 63 and the can 60 were insulated through the insulating gasket 64, and the open end edge of the can 60 was caulked.

Next, a pair of welding electrodes were disposed on the sealing plate and on the bottom portion, and while a pressure was applied between a pair of the welding electrodes, voltage was applied, and welding current flowed. Thus, the positive electrode current collecting lead was connected by welding to the sealing plate.

Then, the open end edge of the can was caulked inward, to thereby produce a nickel metal hydride battery.

The positive electrode current collecting lead 26 was coupled by welding and electrically connected to the sealing plate 63. The opening portion 62 was provided at the center portion of the sealing plate 63, and a valve element 65 was disposed at the opening portion 62 such that the valve element 65 covered the opening portion 62.

A positive electrode cap 67 was provided so as to cover the periphery of the opening portion 62 on the upper surface of the sealing plate 63. A gas vent hole was properly provided at the positive electrode cap 67. A spring member 66 was provided between the inner surface of the positive electrode cap 67 and the valve element 65, and the valve element 65 was pushed by the spring member 66 so as to cover the opening portion 62 of the sealing plate 63. This valve element 65 had a function of a safety valve in which inner pressure can be released at the time of increasing the inner pressure of the can 60.

### Example 1

In preparation of the above nickel sintered positive electrode plate, the bent angle (θ) of the corner tip portion of the positive core substrate tab portion of the spiral electrode assembly was 15°. Except for this, a nickel metal hydride battery was produced in the same way as Example. This nickel metal hydride battery is Battery A1.

### Example 2

In preparation of the above nickel sintered positive electrode plate, the bent angle (θ) of the corner tip portion of the positive core substrate tab portion of the spiral electrode assembly was 45°. Except for this, a nickel metal hydride battery was produced in the same way as Example. This nickel metal hydride battery is Battery A2

### Example 3

In preparation of the above nickel sintered positive electrode plate, the bent angle (θ) of the corner tip portion of the positive core substrate tab portion of the spiral electrode assembly was 60°. Except for this, a nickel metal hydride battery was produced in the same way as Example. This nickel metal hydride battery is Battery A3.

### Example 4

In preparation of the above nickel sintered positive electrode plate, the bent angle (θ) of the corner tip portion of the positive core substrate tab portion of the spiral electrode assembly was 135°. Except for this, a nickel metal hydride battery was produced in the same way as Example. This nickel metal hydride battery is Battery A4.

### Example 5

In preparation of the above nickel sintered positive electrode plate, the bent angle (θ) of the corner tip portion of the positive core substrate tab portion of the spiral electrode assembly was 180°. Except for this, a nickel metal hydride battery was produced in the same way as Example. This nickel metal hydride battery is Battery A5.

### Example 6

In preparation of the above nickel sintered positive electrode plate, the bent angle (θ) of the corner tip portion of the positive core substrate tab portion of the spiral electrode assembly was 0°, namely the curving work was not carried out. Except for this, a nickel metal hydride battery was produced in the same way as Example. This nickel metal hydride battery is Battery A6.

### Battery Test

The above Battery A1 to A6 were used, and the following measurements were carried out.

### Measurement of Defect Rate or Defect

In preparation of Battery A1 to A6, respectively, 200 pieces of the spiral electrode assembly were inserted into the can. Then, after the insulating rings were inserted into the cans, inserting states of the insulating ring were checked by sight, and then a high voltage of 160V was applied to the spiral electrode assembly. At this time, batteries in which a predetermined current value or more flowed due to occurrences of internal short circuits were determined as defective batteries, and then defect rate was measured. Further, a determination was made by sight as to whether the insulating rings were imperfectly inserted.

These results are shown in Table 1.

TABLE 1

| | bent angle of corner tip | | |
|---|---|---|---|
| | portion of positive core | | |
| | substrate tab portion | defect | insertion |
| | θ(°) | rate (%) | defect |
| Battery A6 | 0 | 8 | occurrence |
| Battery A1 | 15 | 0 | occurrence |
| Battery A2 | 45 | 0 | NO |
| Battery A3 | 60 | 0 | NO |
| Battery A4 | 135 | 0 | NO |
| Battery A5 | 180 | 0 | NO |

From the result of Table 1, in Battery A1 to A5 having the bent angle of the corner tip portion of the positive core substrate tab portion, compared with Battery A6 having no bent angle of the corner tip portion of the positive core substrate tab portion, inner short circuits were prevented, and then the detect rate were widely decreased.

It shows that the curving work of having the bent angle of the corner tip portion of the positive core substrate tab portion, surely prevented the corner tip portion of the positive core substrate tab portion from bending in a direction outward a periphery of the spiral electrode assembly and inner short circuiting to the can.

Further, when the bent angle of the corner tip portion of the positive core substrate tab portion is at the range of 45° or more, and 180° or less, there is no insertion defect by inserting the insulating ring, and the insulating rings were perfectly inserted.

From this result, in order to have both effects that the defect rate is decreased and the insertion defect of the insulating ring does not occur, preferably the bent angle of the corner tip portion of the positive core substrate tab portion is at the range of equal to or more than 45° and equal to or less than 180°.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2013-266808 filed in Japan on Dec. 25, 2013, the content of which is incorporated herein by reference.

1. A cylindrical battery comprising:
a spiral electrode assembly having:
a positive electrode plate being provided with a porous nickel sintered substrate using a nickel coated steel plate as a conductive core substrate, and containing a positive electrode active material mainly including a nickel hydroxide;
a negative electrode plate; and
a separator,
wherein the positive electrode plate and the negative electrode plate are wound into a spiral form interposing the separator therebetween,
wherein the positive electrode plate has a positive core substrate tab portion in which the conductive core substrate is exposed without the porous nickel sintered substrate at one end portion in the height direction,
wherein in a winding end portion of the spiral electrode assembly, a corner tip portion of the positive core substrate tab portion is bent toward a winding axis of the spiral electrode assembly.

2. The cylindrical battery according to claim 1,
wherein a bent angle θ of the corner tip portion of the positive core substrate tab portion to the direction to the axis of the spiral electrode assembly is at the range of 45°≦θ≦180°.

3. The cylindrical battery according to claim 1,
wherein the positive electrode plate has a bent portion.

4. The cylindrical battery according to claim 3,
wherein the positive electrode plate is of an approximately rectangular shape, and
the positive electrode plate has a first long side, a second long side, a first short side, and a second short side, and
the positive electrode plate has a bent line, and
the bent line and the first long side cross, and
the bent line and the first short side cross, and
the bent portion is surrounded by the first long side, the first short side, and the bent line.

5. The cylindrical battery according to claim 3,
wherein the bent portion is of a triangular shape.

6. The cylindrical battery according to claim 4,
wherein the bent portion is of a triangular shape.

7. The cylindrical battery according to claim 3,
wherein a positive electrode active material layer is not formed on the bent portion.

8. The cylindrical battery according to claim 4,
wherein a positive electrode active material layer is not formed on the bent portion.

9. The cylindrical battery according to claim 3,
wherein an angle formed by the bent line and the first long side is not 90°, and an angle formed by the bent line and the first short side is not 90°.

10. The cylindrical battery according to claim 2,
wherein when the spiral electrode assembly is seen in the direction parallel to its winding axis and the outermost periphery of the spiral electrode assembly is regarded as a circle, an angle formed by a tangential line and the top side of the bent portion in the crossing point of the bent line and the top long side of the core substrate having a rectangular shape, is θ, and an acute angle.

11. The cylindrical battery according to claim 3,
wherein the bent portion is an approximately plane portion.
